(19) United States
(12) Patent Application Publication
(10) Pub. No.: US 2009/0007053 A1
(43) Pub. Date: Jan. 1, 2009

(54) Method of Manufacturing Mask for Semiconductor Device

(76) Inventor: Young Mi KIM, Gwangsan-gu (KR)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 12/146,772

(22) Filed: Jun. 26, 2008

(30) Foreign Application Priority Data
Jun. 26, 2007 (KR) 10-2007-0062846

(51) Int. Cl. G06F 17/50

(52) U.S. Cl. 716/21

(57) ABSTRACT

A method of manufacturing a mask for a semiconductor device includes checking layout data for a mask in the semiconductor device and correcting any errors in the layout data that violate the design rule, filling small jogs in the layout data, performing optical proximity correction on the jog-filled layout data, and generating a mask pattern using the jog-filled layout data subjected to the optical proximity correction. By this process, it is possible to simplify the layout database to be subjected to optical proximity correction and minimize any errors that may cause unnecessary optical proximity correction (OPC) issues.

This application claims the benefit of Korean Patent Application No. 10-2007-0062846, filed on Jun. 26, 2007 which is hereby incorporated by reference as if fully set forth herein.

### BACKGROUND OF THE INVENTION

1. Field of the Invention

The present invention relates to a method of manufacturing a mask for a semiconductor device, and more particularly, to a method of converting layout data into data having a pattern suitable and/or optimized for optical proximity correction (OPC), performing OPC with respect to the layout data, and forming a mask pattern. Layout data are often considered basic data for generating a mask.

2. Discussion of the Related Art

In a nanometer-scale semiconductor manufacturing process, problems associated with manufacturing, lithography, and/or other process variations may have an influence on the performance of a semiconductor device. Therefore, it is desirable to have accurate information for reliable estimation of the effects of distortion and/or other process variations on semiconductor designs. Typically, semiconductor integrated circuit (IC) fabrication facilities (FABs) have provided layout designers with data relating to manufacturing effects via a series of design rules.

Semiconductor manufacturers can estimate yield based at least in part on these design rules. However, the combined effects of physical layout, sub-wavelength lithography and chip planarization effects may also have a significant influence on yield improvement and maximum yield. In such an environment, successful IC development is facilitated by accurate estimation of the influence on the manufacturing effects.

In nanometer-scale semiconductor manufacturing process technology, a photomask generally is not accurately transferred onto a wafer due to a wavelength diffraction effect. In order to accurately transfer a designed layout onto a wafer, resolution enhancement technologies (RET) such as phase-shift mask (PSM), off-axis illumination (OAI), high NA, sub-resolution assist features (SRAF), and optical proximity correction (OPC) may be used.

By accurately forming the layout design on the wafer, across chip line-width variations (ACLVs) and inter-chip parameter variations can be reduced. OPC may be used for pre-compensating for the reduction of a front end, corner rounding, and a correction edge arrangement error or a pitch bias.

FIG. 1 shows exemplary wafer images resulting from a 0.18-μm process for forming original layout 101 (e.g., a desired layout). Layout pattern 110 is formed without correction. Silicon image 111 shows an actual wave pattern of a semiconductor layout created using layout pattern 110. Layout pattern 120, in contrast, is formed using OPC, resulting in silicon image 121 which more closely matches the original layout 101.

However, lithographic variations may not be incorporated in conventional design rules. As a result, semiconductor devices manufactured using an advanced process may have a low yield and/or may be inoperable, even when manufactured with data which is verified by a design rule check (DRC).

This may occur because lithographic effects at small scales may not be not considered in a process of treating the layout data. Alternatively, while the lithographic effects may be considered, a designer may not understand that particular layout features may be sub-optimal for OPC processing, resulting in defects such as disconnection or shortening of wires.

For example, a pattern called a jog or a notch generally has a convex corner (e.g., an “outer” corner) formed at one end of a side and a concave corner (e.g., an “inner” corner) or a convex corner formed at the other end of the side on a layout. Optical proximity correction may be desirable for such features when the length of the side between the two corners is less than or equal to a length defined by the OPC rule.

FIG. 2 is a view showing an exemplary small jog pattern. In the drawing, small jog 212 has side 201 between convex corner 210 and concave corner 211. Convex corner 210 is defined by sides 201 and 202, and concave corner 211 is defined by the sides 201 and 203. The small jog is a pattern including a side having a less than a minimum length defined by the OPC rules, and may be excluded from a dissection movement target while the OPC is performed.

Dissection is an operation in an OPC process for dissecting and moving corners of a mask pattern. The corner of the mask may be dissected into a plurality of segments and the segments may be moved and arranged in order to improve the optical proximity effect. The positions to which the dissected segments are moved may be determined by the shape and the size of the mask pattern, the structure of another pattern, a simulation result and/or a wafer result.

When OPC is performed on a pattern such as the small jog 212 shown in FIG. 2, the dissected segments may be moved in order to assemble target points generated on sides 202 and 203. Since side 201 is excluded from dissection, the dissected segments of sides 202 and 203 may be unnecessarily moved.

One object of OPC is generally to reproduce a database of metal features (e.g., wires, circuit elements, vias, etc.) patterned on the wafer in a drawn shape. In order to pattern a small jog or a notch which is not patterned on the wafer in an actual lithography process, the OPC process may operate abnormally.

As a result, the complexity of the physical database using OPC may be increased and thus the complexity of the pattern is increased in the manufacture of a reticle. Even in an actual wafer patterning process, the disconnection or shortening of a circuit may be caused due to the abnormal OPC.

FIGS. 3A to 3B show pattern errors which may be caused by an abnormal OPC operation resulting from a small jog. The interconnection layout of a metal layer may be generated by an automatic pattern and replacement (P&R; alternatively, place and route) rule to produce layout 300 of FIG. 3A. Thus, layout 300 may be generated while satisfying only the design rule, and may include small jog patterns 301 and 302.

FIG. 3B shows an exemplary layout result 300′ obtained by performing the OPC with respect to the layout pattern 300 of FIG. 3A. It can be seen that the OPC is performed and the dissected segments are moved such that convex patterns and concave patterns are added to the original layout pattern.

In jog locations 301′ and 302′ of FIG. 3B corresponding to locations 301 and 302 of FIG. 3A, it can be seen that the relatively large concave patterns and convex patterns are formed due to the unnecessary dissection of the small jog and the movement of the dissected segments.

The small jog and the notch pattern reduce OPC accuracy. The pattern of the jog location 302 of FIG. 3A is a layout of a metal line for a damascene process. It can be seen that, when the OPC for patterning the jog portion 302 is performed, a metal line portion connected to the jog is subjected to the OPC such that the size thereof is relatively increased. As a result, an error causing necking may occur at the time of the implementation on the wafer.

If an abnormal OPC operation on a jog pattern produces a pattern which is weak against bridging or necking, then the process margin may become insufficient. In particular, in a relatively unstable portion such as a wafer edge portion, the yield of products on the whole wafer may deteriorate due to disconnection and/or shortening of metal lines.

Furthermore, in order to accurately implement the complicated pattern, the cost of the reticle is increased due to the increase of the time and the cost consumed for testing and repairing the performance of a reticle manufacturing apparatus. Delay of the transfer to the wafer process due to corrections of reticle errors results in delaying the overall progress of a project and thus may have an influence on the product time to market (e.g., market supply and market share).

If the small jog or the notch is not present, the dissected segments may be more easily moved. As a result, the pattern produced by the OPC operation and which will actually be formed on the reticle, is significantly simplified. Accordingly, the reticle can be easily manufactured and an error factor of the wafer processing of the reticle is reduced. Thus, at least under certain conditions, it is desirable to remove small jogs from a semiconductor layout.

### SUMMARY OF THE INVENTION

Accordingly, the present invention is directed to a method of manufacturing a mask for a semiconductor device that substantially obviates one or more problems due to limitations and disadvantages of the related art.

An object of the present invention is to provide a method of manufacturing a mask for a semiconductor device, which is capable of simplifying layout data by filling small jogs in the layout data, facilitating the manufacture of a reticle by removing unnecessary OPC patterns in an OPC flow, increasing process margin(s) by reducing errors such as necking or bridging that may result from unnecessary OPC patterns, and/or improving the yield and the reliability of the device.

Additional advantages, objects, and features of the invention will be set forth in part in the description which follows and in part will become apparent to those skilled in the art upon examination of the following or may be learned from practice of the invention. The objectives and other advantages of the invention may be realized and attained by the structure(s) and process(es) particularly pointed out in the written description and claims hereof as well as the appended drawings.

To achieve these objects and other advantages and in accordance with the purpose of the invention, as embodied and broadly described herein, a method of manufacturing a mask for a semiconductor device includes checking a design rule of layout data of the semiconductor device and correcting an error of the layout data which deviates from the design rule, filling small jogs by reversing optical proximity correction in the layout data, performing optical proximity correction on the jog-filled layout data (i.e., the layout data in which the small jogs are filled), and generating a mask pattern using the jog-filled layout data subjected to optical proximity correction. In the context of the present application, a small jog may be considered to be a pattern having at least one side and at least one corner having less than a minimum length. In one embodiment, the minimum length is a critical dimension of the manufacturing technology.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle(s) of the invention. In the drawings:

FIG. 1 is a view showing exemplary wafer images in the case where a layout pattern is formed without optical proximity correction (OPC) and in the case where a layout pattern is formed with OPC;

FIG. 2 is a view showing an exemplary small jog pattern;

FIGS. 3A to 3B are views showing exemplary pattern errors which may be caused by OPC on small jog patterns;

FIG. 4 is a flowchart illustrating an exemplary method of manufacturing a mask using OPC;

FIG. 5 is a flowchart illustrating an exemplary embodiment of method of manufacturing a mask including a jog-fill process;

FIGS. 6A to 6C are views of exemplary OPC results when the jog-fill process is not performed and when the jog-fill process is performed with respect to layout data, according to an embodiment of the present invention;

FIGS. 7A to 7B are views showing aerial image intensity in the case where the OPC is performed without the jog-fill process and in the case where the OPC is performed with the jog-fill process, with respect to an exemplary layout pattern of a metal layer; and

FIGS. 8A and 8B are views showing exemplary layout patterns before and after performing OPC and exemplary simulation and wafer images in the case where the jog-fill process is not performed and in the case where the jog-fill process is performed.

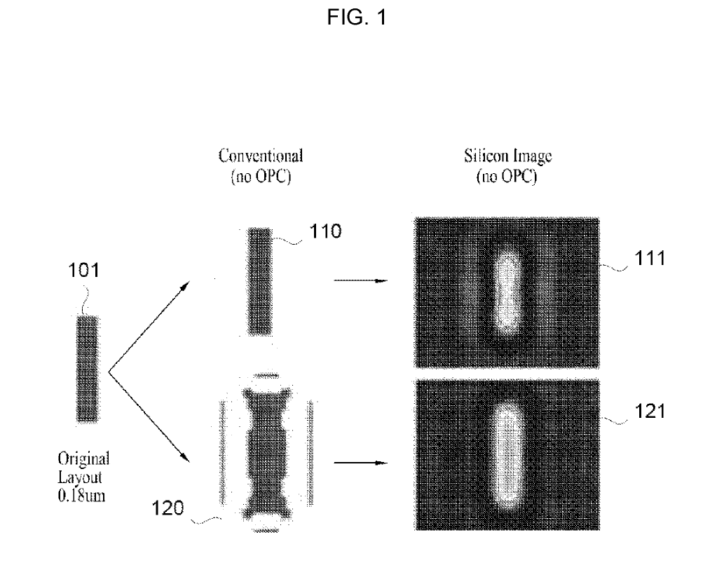

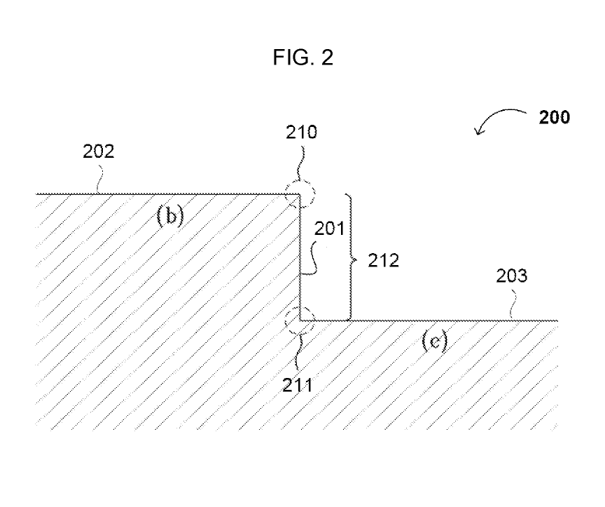

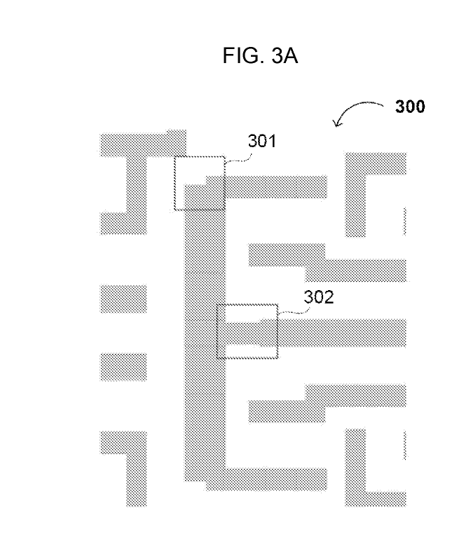

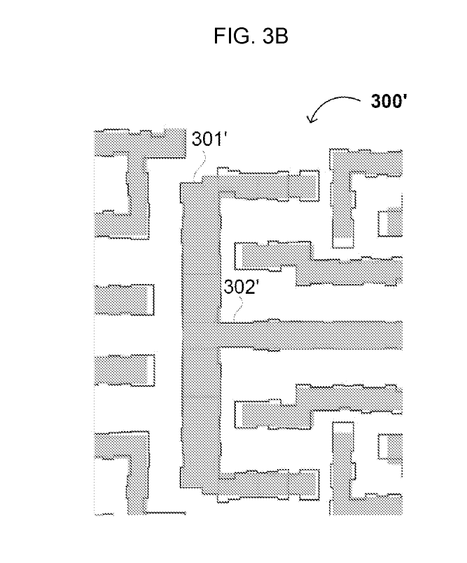

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

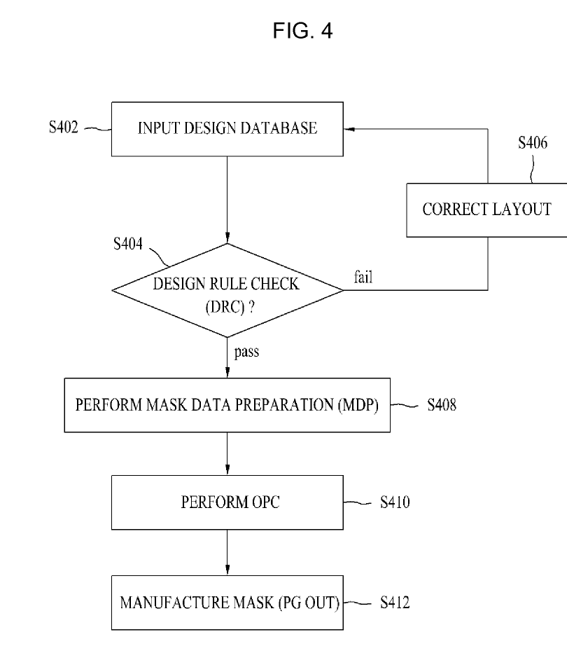

FIG. 4 is a flowchart illustrating an exemplary method of manufacturing a mask using optical proximity correction al (OPC). First, a design database input step (S402) of inputting the design database to a mask manufacturing process is performed. For example, after a project tape-out, a design database may be sent to a semiconductor fabrication plant (FAB) to perform this processing based on the manufacturing characteristics of the FAB.

A design rule check (DRC) step (S404) of checking whether or not the layout of the input database is drawn according to a design rule is performed, and a layout correcting step (S406) of correcting errors is performed if a design error or a violation against the design rule is found.

The layout which is subjected to the DRC step is subjected to a mask data preparation (MDP) step (S408). The MDP step may include, for example, generating a photo alignment key, an overlay key, a process control monitoring (PCM) pattern, a CD monitoring pattern and/or a dummy pattern of a mask framework for design and manufacture of a mask.

Thereafter, an OPC step (S410) is performed. If there is no abnormality in the verification of the OPC, a mask manufacturing step (PG-out) (S412) may be performed to produce an output database for manufacturing the reticle. The mask manufacturing step may include, for example, changing the layout data of the circuit design pattern to data which can be used by a reticle/mask manufacturing apparatus, inputting the data, and/or forming a target mask pattern is performed.

In the method of manufacturing the mask according to an exemplary embodiment, a step (hereinafter, referred to as a jog-fill step) of checking whether or not a pattern which is called a small jog and defined by an OPC engineer is present in the database and filling the small jogs and removing the small jogs from the layout data if the patterns are present is performed before the step of performing the OPC.

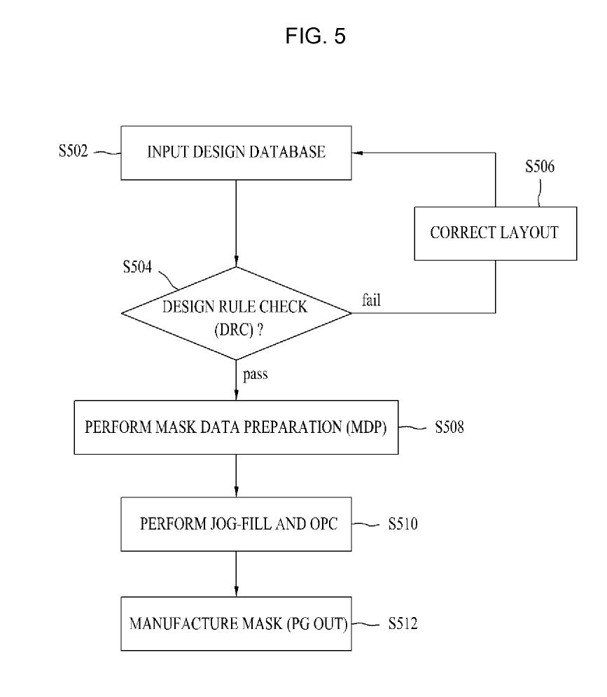

FIG. 5 is a flowchart illustrating a method of manufacturing a mask using OPC including a jog-fill step according to an exemplary embodiment. First, a design database input step (S502) is performed to input a design database to a mask manufacturing process. A DRC step (S504) of checking whether or not the layout of the sent database is drawn according to a design rule provided by a customer is performed, and a layout correcting step (S506) of correcting an error is performed if a design error or a violation against the design rule is found.

The layout which is subjected to the DRC step is subjected to a mask data preparation (MDP) step (S508). The MDP step may include, for example, generating a photo alignment key, an overlay key, a process control monitoring (PCM) pattern, a CD monitoring pattern and/or a dummy pattern of a mask framework for design and manufacture of a mask.

Thereafter, a jog-fill and/or OPC step (S510) may be performed. The jog-fill step may include checking whether or not a small jog pattern is present in the layout data output from step S508 and filling the small jogs (e.g., prior to performing OPC) the layout data if the patterns are present, and an OPC performing step are performed.

A further verification step may be performed to detect abnormality (e.g., excessive complexity) in the OPC output. If there is no abnormality in verification of the OPC, a mask manufacturing step (PG-out) (S512) may be performed to produce an output database for manufacturing a reticle. The mask manufacturing step may include, for example, changing the layout data of the circuit design pattern to data which can be used by a reticle/mask manufacturing apparatus, inputting the data, and/or forming a target mask pattern.

In another embodiment of the present invention, in the jog-fill and OPC performing step (S510), a step of performing the DRC with the layout data may be performed. This step may include detecting errors in the layout (e.g., errors introduced by the jog-fill step) and/or correcting any errors found between the jog-fill step and the OPC step.

A small jog is generally a pattern including a side between two corners (e.g., between a concave corner and a convex corner, between two convex corners, etc.) where the length of the side between the two corners is less than or equal to a length defined by an OPC rule. This minimum length may be provided, for example, by user input (e.g., from an OPC engineer), from a memory and/or storage, etc. Each of the small jogs may have a convex corner (e.g., an “outer” corner having an angle of approximately 90 degrees) formed at one end of the side and either a concave (e.g., an “inner” corner having an angle of approximately 270 degrees) or a convex corner formed at the other end of the side.

The jog-fill step may include filling the small jogs such that the output layout data in which the small jogs are filled does not violate applicable design rules.

The mask pattern data generated by the present methods may be used, for example, to form metal layers including wires, contacts and/or vias.

The jog-fill step may including filling small jogs located adjacent to patterns in the mask pattern that may otherwise (e.g., in the absence of the present jog-fill step) cause necking or bridging (e.g., in metal lines) due to a small process margin.

The DRC may be repeated after performing the jog-fill step (e.g., to determine whether the jog-fill step caused any design rule violations) before the step of performing the OPC. Furthermore, the jog-fill step and any supplemental DRC step may be performed iteratively.

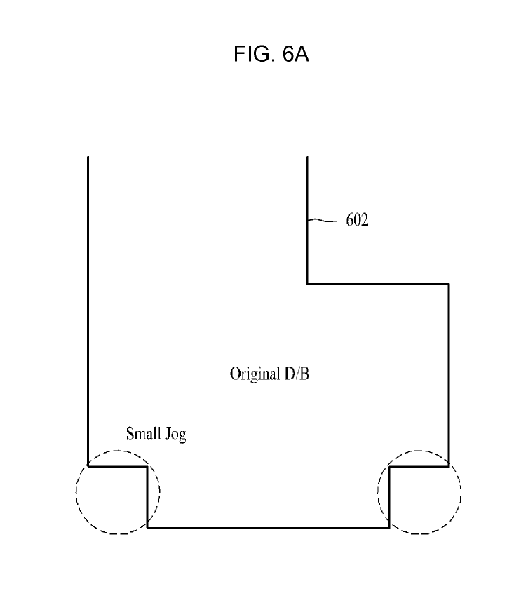

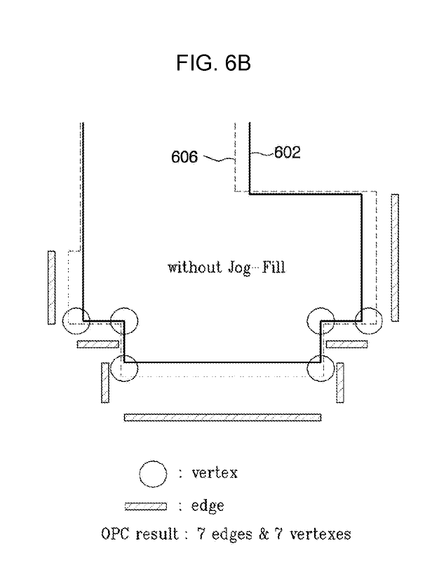

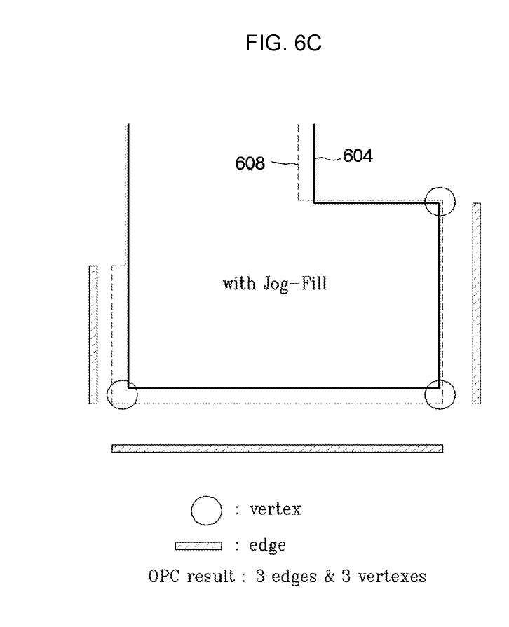

FIGS. 6A to 6C are views demonstrating a comparison between OPC results without the present jog-fill process and PC results when the present jog-fill process is performed with respect to exemplary layout data.

FIG. 6A shows an exemplary original layout pattern 602 with small jogs 610 and 611. FIG. 6B shows the original layout pattern 602 and an exemplary OPC result pattern 606 superimposed thereon, where the jog-fill process is not performed to produce pattern 606. FIG. 6C shows a pattern 604 in which small jogs are removed by performing the jog-fill process and an OPC result pattern 608 based on a filled pattern 604.

Referring to FIG. 6B, pattern 602 has seven vertexes (e.g., which may be the dissection units in the OPC process). Thus, OPC output pattern has seven corresponding generated edges. Referring now to FIG. 6C, jog-filled pattern 602 has three vertexes corresponding to three edges in OPC output pattern 608. Thus, in the case where the OPC is performed after the jog-fill process is performed, the number of vertexes which are the dissection units is reduced, the number of generated edges is reduced, and the form of the database after performing the OPC is simplified. Accordingly, it is possible to reduce errors due to corner rounding in the manufacture of the reticle and reduce manufacturing errors which may occur when manufacturing the reticle by simplifying the complicated pattern and simplifying the OPC result.

When the jog-fill process is performed, the following points should be noted. First, the device characteristics should not be changed by the jog-fill process. Accordingly, it may be difficult to apply the jog-fill process to a specific layer such as an active area and a control gate. Device characteristics should be checked to determine wither they are influenced by the present operations. Second, a design rule violation should not be introduced by the present jog-fill process. Since the jog-fill process may add a polygon to the jog or the notch, the space between features may be reduced, which may result in a space smaller than permitted by the applicable design rules. As a result, bridging may occur.

Table 1, below, shows the number of polygons, the number of small jogs and the OPC run time of the layout database in the case where the jog-fill process is performed with respect to a database of a metal 1 layer (e.g. with a line/space design rule of 160/180 using an Al process) of a 0.13-μm CMOS image sensor (CIS).

TABLE 1

| | | Number of | | |
|---|---|---|---|---|
| | | polygons | Number of | OPC run time, |
| | Number of | after jog- | removed | min |
| | original | fill process | small jogs | (original/ |
| Database | polygons | is performed | (%) | jog-fill) |
| 0.13 μm, | 15244720 | 15335291 | 148797 | 80/75 |
| Process A | | | (1.0%) | |
| (apply the | | | | |
| library of | | | | |
| Company A) | | | | |
| 0.13 μm, | 15300451 | 15711662 | 494337 | 94/89 |
| Process B | | | (3.2%) | |
| (apply the | | | | |
| library of | | | | |
| Company B) | | | | |
| 0.13 μm | 22379416 | 24021082 | 2706119 | 306/289 |
| | | | (12.1%) | |

Referring to Table 1, in the case where the CIS database is subjected to the jog-fill process, the OPC result pattern is simplified and thus the OPC run time is slightly reduced. As can be seen from a fourth row and a fourth column of the table, in the case where a large number of logic patterns are distributed in the database, the number of small jogs is reduced by about 12%. As a result, it can be seen that the OPC run time is reduced after the jog-fill process.

Since the jog-fill process is performed using geometric characteristics according to the design rule, it does not take much time. In exemplary embodiments, the jog-fill run time is less than 5 min. This is close to the reduction in OPC run time due to the jog-fill process. Thus, the overall processing time including the jog-fill process may not be substantially increased by including the jog-fill process. Furthermore, the number of polygons which are subjected to the jog-fill process is generally not large compared to the size of the total database.

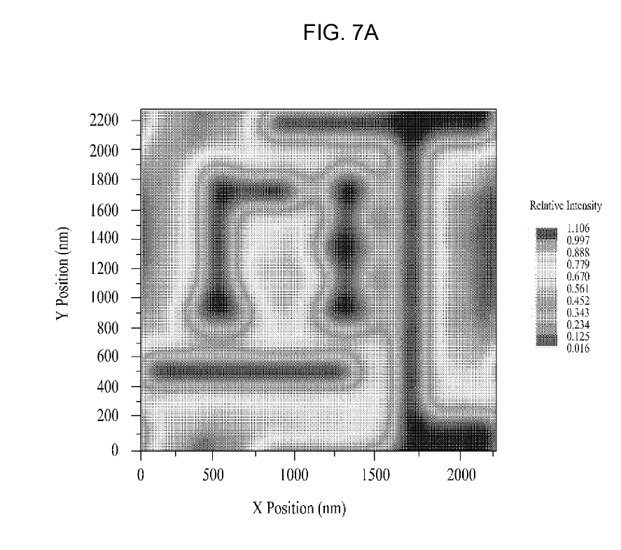

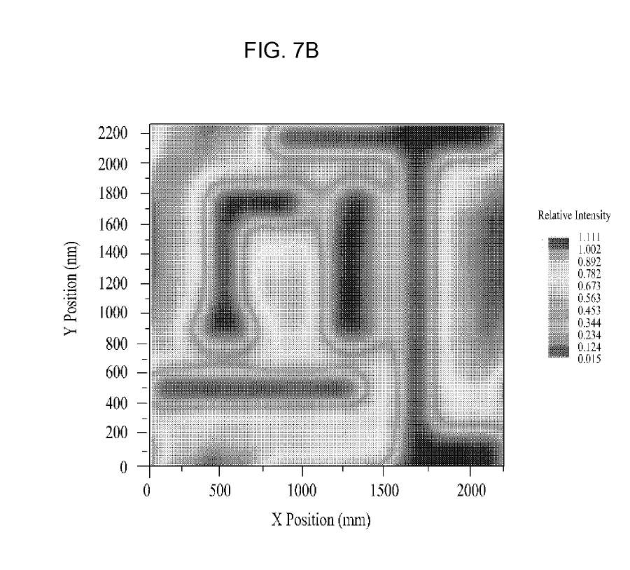

FIGS. 7A and 7B are views showing aerial image intensity in the case where the OPC is performed without the jog-fill process and in the case where the OPC is performed with the jog-fill process, with respect to an exemplary layout pattern for a metal layer.

As the design rule is decreased and the pattern density of the layout is increased, the pattern margin of the process is correspondingly decreased. FIG. 7A shows an aerial image intensity of an exemplary device where the OPC is performed without the jog-fill process. FIG. 7B shows an aerial image intensity of an exemplary device where case where the present jog-fill process is performed with OPC.

In FIG. 7B, it can be seen that a change in pattern profile according to a process variable is more stable than that of the pattern of FIG. 7A. As a result, the process margin for disconnection and shortening of metal wires is increased when the jog-fill process is used. Since the area of the metal line is larger when the jog-fill process is performed (as shown in FIG. 7B), it can be seen that the process margin can be increased even in the contact/via-layer overlap portion.

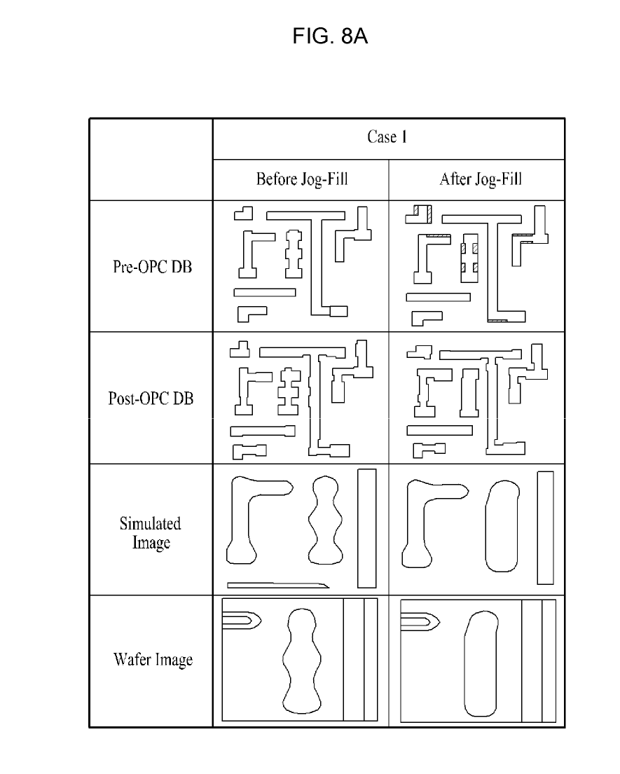

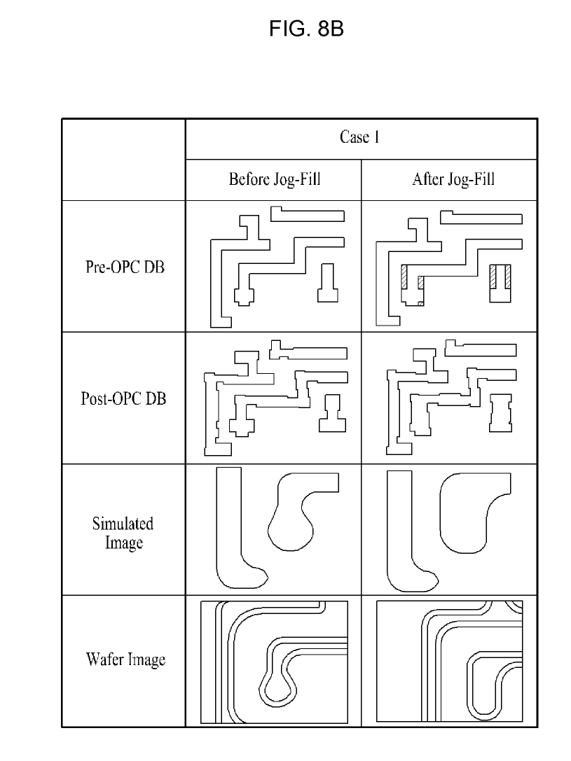

FIGS. 8A and 8B are views showing exemplary patterns before and after OPC, and exemplary simulation and wafer images in the case where the jog-fill process is not performed and in the case where the jog-fill process is performed.

In the wafer image of the pattern of a first exemplary pattern (Case I) shown in the last row of FIG. 8A, in the case where the OPC is performed before the jog-fill process, a necking phenomenon in which the pattern is contacted appears in midway positions. In contrast, the jog-fill process is also performed the line-width of the pattern is stable. The same may be seen in the wafer image of a second exemplary pattern (Case II) shown in the last row of FIG. 8B.

From the wafer image result, it can be seen that the pattern which is formed in the wafer after OPC may be weak against pinch phenomena, necking, and/or bridging, but may be more stably patterned by performing the present jog-fill process.

As described above, in the method of manufacturing the mask for the semiconductor device according to the present invention, it is possible to simplify layout data by filling small jogs of the layout data, facilitate the manufacture of a reticle by removing an unnecessary OPC result pattern on an OPC flow, increase a process margin by reducing errors such as a pinch phenomena, necking, and/or bridging which may be caused by unnecessary and/or excessive edges in an OPC result pattern, thereby improving the yield and the reliability of the device.

Embodiments of the present invention also include algorithms, computer program(s) and/or software, implementable and/or executable in a general purpose computer or workstation equipped with a conventional digital signal processor, configured to perform one or more of the operations disclosed herein. Thus, a further aspect of the invention relates to algorithms and/or software that implement the above method(s). For example, the invention may further relate to a computer program, computer-readable medium or waveform containing a set of instructions which, when executed by an appropriate processing device (e.g., a signal processing device, such as a microcontroller, microprocessor or DSP device), is configured to perform the above-described method and/or algorithm.

For example, the computer program may be on any kind of readable medium, and the computer-readable medium may comprise any medium that can be read by a processing device configured to read the medium and execute code stored thereon or therein, such as a floppy disk, CD-ROM, magnetic tape or hard disk drive. Such code may comprise object code, source code and/or binary code.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of manufacturing a mask for a semiconductor device, the method comprising:
checking layout data for the mask for a violation of a design rule, and correcting one or more errors in the layout data that violate the design rule;
filling small jogs in the layout data;
performing optical proximity correction on the jog-filled layout data; and
generating a mask pattern using the jog-filled layout data subjected to optical proximity correction.

2. The method according claim 1, further comprising, before the step of performing optical proximity correction, further checking the jog-filled layout data again and correcting any error that violates the design rule.

3. The method according to claim 1, wherein each of the small jogs comprises a pattern having at least one side and at least one corner having less than a minimum length.

4. The method according to claim 3, wherein the minimum length is a critical dimension of the manufacturing technology for manufacturing the semiconductor device.

5. The method according to claim 1, wherein each of the small jogs has a convex corner at one end of a first side and a concave corner or a convex corner at another end of the first side.

6. The method according to claim 3, wherein filing the small jogs comprises adding a polygon and removing a side of the small jogs having less than the minimum length.

7. The method according to claim 1, wherein the jog-filled layout data does not violate the design rule.

8. The method according to claim 1, wherein the mask pattern is used to form a metal layer, a contact layer or a via layer.

9. The method according to claim 1, wherein the small jogs are adjacent to a pattern that causes necking or bridging.

10. The method according to claim 9, wherein the necking or bridging is due to a small process margin in the mask pattern.

11. The method according to claim 1, wherein, in the step of filling the small jogs, a run time is 0.3 to 5 min.

12. The method according to claim 1, wherein the step of performing the optical proximity correction on the jog-filled layout data has a reduced run time after filling the small jogs.

13. The method according to claim 1, further comprising, after the step of checking the layout data for violations of the design rule and correcting the design rule violations, performing a mask data preparation process.

14. The method according to claim 13, wherein the mask data preparation process comprises generating an overlay key for the layout in which the design rule is checked.

15. The method according to claim 13, wherein the mask data preparation process comprises generating a process control monitoring (PCM) pattern, a CD monitoring pattern and a dummy pattern for the layout in which the design rule is checked.

16. The method according to claim 14, wherein the mask data preparation process comprises generating a process control monitoring (PCM) pattern, a CD monitoring pattern and a dummy pattern for the layout in which the design rule is checked.
